(19) United States
(12) Patent Application Publication
(10) Pub. No.: US 2007/0150549 A1
(43) Pub. Date: Jun. 28, 2007

(54) Portable recording and/or playback apparatus and operation method thereof

(75) Inventors: Jong-eun Won, Seoul (KR); Young-chul Sohn, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/585,980

(22) Filed: Oct. 25, 2006

(30) Foreign Application Priority Data
Dec. 23, 2005 (KR) 10-2005-0128700

(51) Int. Cl. G06F 15/167

(52) U.S. Cl. 709/213

(57) ABSTRACT

A portable apparatus and an operation method thereof are provided. The method includes accessing information on resources of a second portable apparatus, if the second portable apparatus is connected to a first portable apparatus; and operating the first portable apparatus using the accessed information on resources and information on resources of the first portable apparatus. The portable apparatus includes a connector which connects a first portable apparatus and a second portable apparatus; a storage unit which stores information on content and information on resources; a control unit which accesses information on resources, and controls the operation of the first portable apparatus using the accessed information on resources; and an output unit which outputs a signal, under the control of the control unit, wherein the storage unit outputs content data requested by the control unit.

### CROSS-REFERENCE TO RELATED PATENT APPLICATION

This application claims priority from Korean Patent Application No. 10-2005-0128700, filed on Dec. 23, 2005, in the Korean Intellectual Property Office, the disclosure of which is incorporated herein in its entirety by reference.

### BACKGROUND OF THE INVENTION

1. Field of the Invention

Apparatuses and methods consistent with the present invention relate to portable recording and/or playback, and more particularly, to a portable recording and/or playback apparatus capable of sharing resources with another portable recording and/or playback apparatus, and an operation method thereof.

2. Description of the Related Art

An MP3 player and a digital media player are examples of portable apparatuses. The digital media player includes a storage unit which stores content, a speaker which outputs sound, a decoder which decodes content stored in the storage unit, and a battery. The content stored in the storage unit may be audio content.

The MP3 player includes a storage unit which stores content, a speaker which outputs sound, a display unit which displays a user interface and/or video content, a decoder which decodes content stored in the storage unit, and a battery. The content stored in the storage unit may be audio content and/or multimedia content composed of audio content and video content. The video content may be motion pictures or still pictures.

Besides the MP3 and the digital media player, an audio playback only apparatus or an audio/video playback only apparatus are also portable apparatuses.

The portable apparatuses can each store different content. Also, the portable apparatuses may have asymmetrical structures, thereby providing different functions. For example, a portable recording and/or playback apparatus may provide a display function, an FM reception function, and a recording function, whereas another portable recording and/or playback apparatus may provide a content playback function only.

In this case, if two people having their own portable apparatuses wish to listen to the same content at the same time and place, they have to share an earphone plugged into one of the apparatuses containing that content. Alternatively, the apparatus containing the content can be connected to an audio stereo distributor, and they have to use two earphones plugged into the audio stereo distributor.

For this reason, if they wish to listen to different content respectively stored in the two portable apparatuses, one of the two apparatuses has to be first connected to the stereo audio distributor and then later swapped for another apparatus. Namely, according to the content to be played, they have to change connections between the apparatuses and the stereo audio distributor.

In addition, functions provided by one portable recording and/or playback apparatus cannot be shared with another portable recording and/or playback apparatus. For example, if two users wish to use an FM reception function at the same time, and the FM reception function is provided by only one of the two portable apparatuses, the portable recording and/or playback apparatus having the FM reception function has to be connected to the stereo audio distributor.

### SUMMARY OF THE INVENTION

The present invention provides a portable recording and/or playback apparatus that can share resources with another portable recording and/or playback apparatus, and an operation method thereof.

The present invention also provides a portable recording and/or playback apparatus that can share resources with another portable recording and/or playback apparatus having a different structure, and an operation method thereof.

According to an aspect of the present invention, there is provided a method of operating portable apparatuses, the method comprising accessing information on resources of a second portable apparatus, if the second portable apparatus is connected to a first portable apparatus; and operating the first portable apparatus using the accessed information on resources and information on resources of the first portable apparatus.

According to another aspect of the present invention, there is provided a portable recording and/or playback apparatus comprising a connector which connects a first portable apparatus and a second portable apparatus; a storage unit which stores information on content and information on resources of the first portable apparatus; a control unit which accesses information on resources of the second portable apparatus if the second portable apparatus is connected to the connector, and controls the operation of the first portable apparatus using the accessed information on resources and information on resources stored in the storage unit; and an output unit which outputs a signal received from the storage unit or the connector, under the control of the control unit, wherein the storage unit outputs content data requested by the control unit, to the output unit and the connector.

### BRIEF DESCRIPTION OF THE DRAWINGS

The above and other aspects of the present invention will become more apparent by describing in detail certain exemplary embodiments thereof with reference to the attached drawings in which:

FIG. 1 illustrates portable apparatuses according to an exemplary embodiment of the present invention;

FIG. 2 is a block diagram of a portable recording and/or playback apparatus according to an exemplary embodiment of the present invention;

FIG. 3 is a block diagram of a portable recording and/or playback apparatus according to another exemplary embodiment of the present invention;

FIG. 4 illustrates an example of information on resources displayed on a display unit of FIG. 3;

FIG. 5 is a block diagram of a portable recording and/or playback apparatus according to still another exemplary embodiment of the present invention;

FIG. 6 is a block diagram of a portable recording and/or playback apparatus according to yet another exemplary embodiment of the present invention;

FIG. 7 is a block diagram of a portable recording and/or playback apparatus according to yet another exemplary embodiment of the present invention;

FIG. 8 is a block diagram of a portable recording and/or playback apparatus according to yet another exemplary embodiment of the present invention;

FIG. 9 is a flowchart of an operation method of a portable recording and/or playback apparatus according to an exemplary embodiment of the present invention;

FIG. 10 is a detailed flowchart of the operation 903 of FIG. 9; and

FIG. 11 is a detailed flowchart of the operation 1004 of FIG. 10.

### DETAILED DESCRIPTION OF EXEMPLARY EMBODIMENTS OF THE PRESENT INVENTION

The present invention will now be described in detail by explaining certain exemplary embodiments of the invention with reference to the attached drawings.

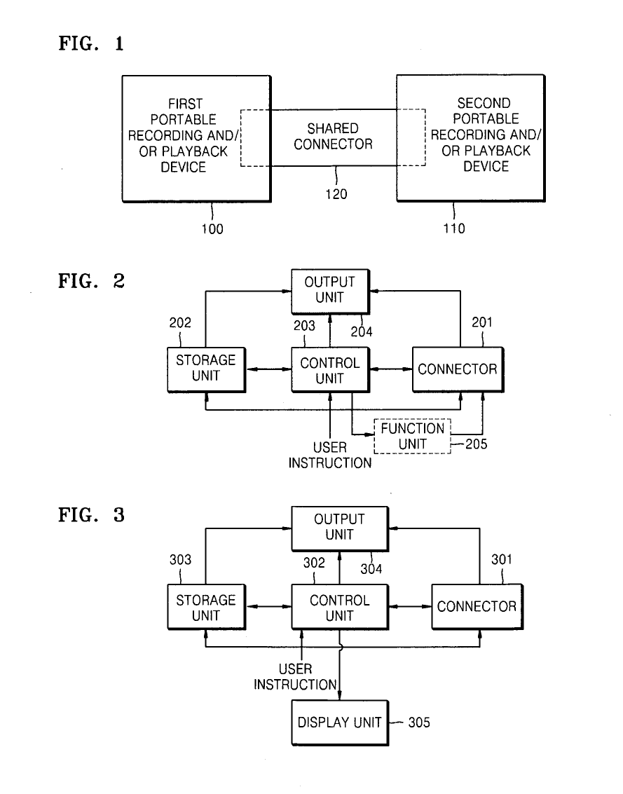

FIG. 1 illustrates portable apparatuses according to an exemplary embodiment of the present invention. Referring to FIG. 1, a first portable recording and/or playback apparatus 100 and a second portable recording and/or playback apparatus 110 are connected through a shared connector 120, to share resources therebetween.

The first portable recording and/or playback apparatus 100 and the second portable recording and/or playback apparatus 110 may have a symmetrical structure or an asymmetrical structure with each other. Here, having a symmetrical structure denotes that the first portable recording and/or playback apparatus 100 and the second portable recording and/or playback apparatus 110 each have the same elements, and having an asymmetrical structure denotes that the first portable recording and/or playback apparatus 100 and the second portable recording and/or playback apparatus 110 each have different elements. The first portable recording and/or playback apparatus 100 and the second portable recording and/or playback apparatus 110 may be MP3 players, digital media players, or similar devices.

Through the shared connector 120, the first portable recording and/or playback apparatus 100 and the second portable recording and/or playback apparatus 110 send and receive audio data and bit stream data between each other. Alternatively, the first portable recording and/or playback apparatus 100 and the second portable recording and/or playback apparatus 110 may also share power with each other through the shared connector 120.

By using the first portable recording and/or playback apparatus 100, the user of the first portable recording and/or playback apparatus 100 can use content and functions of the second portable recording and/or playback apparatus 110 along with those of the first portable recording and/or playback apparatus 100. Also, by using the second portable recording and/or playback apparatus 110, the user of the second portable recording and/or playback apparatus 110 can use content and functions of the first portable recording and/or playback apparatus 100 along with those of the second portable recording and/or playback apparatus 110.

While the user of the first portable recording and/or playback apparatus 100 and the user of the second portable recording and/or playback apparatus 110 use the same content or functions, the user of the first portable recording and/or playback apparatus 100 and the second portable recording and/or playback apparatus 110 may stop a corresponding apparatus or change an operation condition of a corresponding apparatus by one of the two apparatuses 100 and 110. When playing audio content, the operation condition may be related to which decoder will be chosen between a decoder included in the first portable recording and/or playback apparatus 100 or a decoder included in the second portable recording and/or playback apparatus 110, to decode audio data to be played.

FIG. 2 is a block diagram of a portable recording and/or playback apparatus according to an exemplary embodiment of the present invention. The first portable recording and/or playback apparatus 100 and the second portable recording and/or playback apparatus 110 of FIG. 1 may have the same structure as shown in FIG. 2.

Referring to FIG. 2, the portable recording and/or playback apparatus includes a connector 201, a storage unit 202, a control unit 203, and an output unit 204. Hereinafter, the portable recording and/or playback apparatus will be referred to as the apparatus, for convenience.

The connector 201 connects between apparatuses on a hardware level. For example, if FIG. 2 is a block diagram of the first apparatus 100, the connector 201 connects between the first apparatus 100 and the second apparatus 110 on a hardware level. The connector 201 may be connected to the second apparatus 110 through the shared connector of FIG. 1. The connector 201 sends and receives audio data and bit stream data. For this, the connector 201 may include a bit stream data share line and an audio data share line. However, one having ordinary skill in the art will recognize that may different configurations of the connector 201 are possible.

When content stored in the first apparatus 100 or functions of the first apparatus 100 are used while the first apparatus 100 is connected to the second apparatus 110, audio data and/or bit stream data is sent from the first apparatus 100 to the second apparatus 110 through the connector 201, under the control of the control unit 203. On the other hand, when content stored in the second apparatus 110 or functions of the second apparatus 110 are used while the first apparatus 100 is connected to the second apparatus 110, audio data and/or bit stream data is sent from the second apparatus 110 to the first apparatus 100 through the connector 201, under the control of the control unit 203.

In the connector 201, the path for sending the audio data and the bit stream data from the first apparatus 100 to the second apparatus 110 may be different from the path for sending the audio data and the bit stream data from the second apparatus 110 to the first apparatus 100.

The shared connector 120 of FIG. 1 used in the apparatus of FIG. 2 sends and receives audio data and bit stream data. If the shared connector 120 is a male connector, the connector 201 of the apparatuses is a female connector. Likewise, if the shared connector 120 is a female connector, the connector 201 is a male connector.

The storage unit 202 stores one or more content and information on resources of the first apparatus 100. The information on resources may be stored in a file system. The information on resources of the first apparatus 100 may include information on content stored in the first apparatus 100 and/or information on functions included in the first apparatus 100. If the information on resources has a hierarchical structure based on folders and files, the information on resources may be defined using content names and function names. The information on content may be classified and managed based on various conditions such as content types.

If the first apparatus 100 has a content playback and/or recording function only, the information on functions stored in the first apparatus 100 is not stored in the storage unit 202. This is because the content playback and/or recording function is excluded in the information on functions of the first apparatus 100. For example, if the function unit 205 indicated by a dotted line in FIG. 2 can accept FM radio, the information on functions of the first apparatus 100 includes information on an FM reception function. The reason why the function unit 205 is indicated by a dotted line is that the function unit 205 may not be an element of the first apparatus 100.

The storage unit 202 provides the information on resources to the control unit 203. In addition, when the control unit 203 requests the output of content, the storage unit 202 outputs the requested content to the output unit 204 and the connector 201.

If the second apparatus 110 is connected to the connector 201, the control unit 203 accesses information on resources of the second apparatus 110 through the connector 201. According to the accessed information and the information on resources of the first apparatus 100 stored in the storage unit 202, the control unit 203 controls operation of the first apparatus 100.

When content selected by a user instruction is stored in the storage unit 202, the control unit 203 requests the storage unit 202 to output data corresponding to the selected content. At the same time, the control unit 203 controls the connector 201 and the output unit 204, so that the content data that is sent from the storage unit 202 is output to the first apparatus 100 and sent to the second apparatus 110.

On the other hand, when content selected by a user instruction exists in the second apparatus 110, the control unit 203 requests the second apparatus 110 to play the selected content through the connector 201. When content data is received through the connector 201, the control unit 203 controls the output unit 204 and the connector 201, so that the content data is output through the output unit 204.

If a user instruction requests content data stored in the second apparatus 110 to be copied to the first apparatus 100, the control unit 203 reads the content data from the second apparatus 110 through the connector 201, and controls the connector 201 and the storage unit 202 so that the content data is stored in the storage unit 202.

If a user instruction requests content data stored in the first apparatus 100 to be copied to the second apparatus 110, or if any content data stored in the storage unit 202 is requested through the connector 201, the control unit 203 controls the storage unit 202 and the connector 201 so that the selected content data stored in the storage unit 202 is sent to the second apparatus 110 through the connector 201.

If a user instruction requests the deletion of content stored in the first apparatus 100, the control unit 203 deletes that content from the storage unit 202. If the user instruction requests the deletion of content stored in the second apparatus 110, the control unit 203 requests the second apparatus 110 to delete that content, through the connector 201.

With the second apparatus 110 connected, if the function unit 205 is included in the first apparatus 100, and a user instruction requests the operation of the function unit 205, the control unit 203 operates the function unit 205, and the function unit 205 performs the relevant function. A signal generated by the function unit 205 is sent to the second apparatus 110 through the connector 201. If the first apparatus 100 does not include the function unit 205, the user instruction cannot request the operation of the function unit 205.

On the other hand, with the second apparatus 110 connected, if a user instruction requests the operation of the function unit 205 included in the second apparatus 110, the control unit 203 requests the second apparatus 110 to perform the relevant function, through the connector 201. If a signal generated in the process of performing the function is received through the connector 201, the control unit 203 controls the connector 201 and the output unit 204, so that the received signal is output through the output unit 204.

Under the control of the control unit 203, the output unit 204 outputs a signal received from the storage unit 202 or the connector 201. The output unit 204 may be an audio output element such as an earphone.

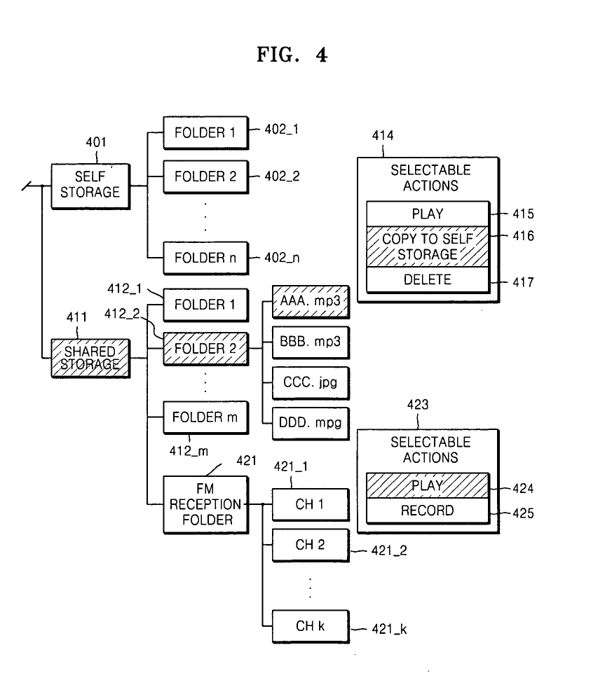

FIG. 3 is a block diagram of a portable recording and/or playback apparatus according to another exemplary embodiment of the present invention. Referring to FIG. 3, the apparatus includes a connector 301, a control unit 302, a storage unit 303, an output unit 304, and a display unit 305.

The connector 301, the storage unit 303, and the output unit 304 of FIG. 3 respectively have the same structure and operation as the connector 201, the storage unit 202, and the output unit 204 of FIG. 2.

The display unit 305 displays information on resources provided by the control unit 302. The information on resources may be provided on a user interface form. Accordingly, user instructions can be input to the control unit 302 through the display unit 305. The information on resources is the same as described in FIG. 2, and may be displayed as shown in FIG. 4. FIG. 4 illustrates an example of information on resources displayed on the display unit 305 of FIG. 3.

Referring to FIG. 4, a self storage 401, that is, the storage unit 303 of the first apparatus 100, includes n folders 402_1 to 402_{—}n. Content is stored in the n folders 402_1 to 402_{—}n. The apparatus of FIG. 3 does not include the function unit 205 of FIG. 2. If the apparatus of FIG. 3 includes the function unit 205 of FIG. 2, a folder is further included in the self storage 401 to manage resources of the function unit 205.

Also, referring to FIG. 4, a shared storage 411, that is, a storage unit (not shown) of the second apparatus 110, includes m folders 412_1 to 412_{—}m and an FM reception folder 421 which is used to manage resources for FM reception.

As shown in FIG. 4, when a user selects a content file “AAA.mp3” in the second folder 412_2 of the shared storage 411, a popup menu 414 containing information on selectable actions is displayed on the display unit 305 under the control of the control unit 302, to indicate selectable actions for the selected content file. The popup menu 414 allows the selection of actions to play 415, copy to self storage 416, and delete 417 for the selected content file. In FIG. 4, the action of “copy to self storage” 416 is selected.

On the other hand, when content files stored in the n folders 402_1 to 402_{—}n included in the self storage 401 are selected, the popup menu 414 containing selectable action may be displayed on the display unit 305 under the control of the control unit 302. In this case, the action of “copy to self storage” 416 may be defined as “copy to shared storage” or “copy to second apparatus”.

Also, if the user selects a CH1 421_1 of the FM reception folder 421, a popup menu 423 containing selectable actions is displayed on the display unit 305 under the control of the control unit 302. The popup menu 423 allows the selection of actions to play or record. If the play action is selected based on the popup menu 423, the control unit 302 requests to the second apparatus 110 through the connector 301 to perform FM reception of the CH1 421_1. As a result, if a signal generated by the second apparatus 110 is received through the connector 301, the control unit 302 allows the received signal to be output through the output unit 304. The signal generated by the second apparatus 110 is an FM radio signal received through the CH1 421_1.

If the record action is selected based on the popup menu 423, the control unit 302 stores the signal received through the connector 301 into the storage unit 303.

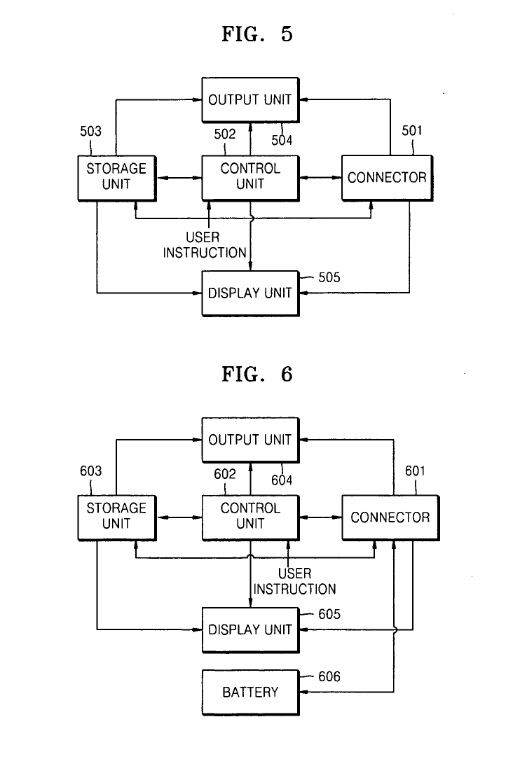

FIG. 5 is a block diagram of a portable recording and/or playback apparatus according to still another exemplary embodiment of the present invention. Referring to FIG. 5, the apparatus includes a connector 501, a control unit 502, a storage unit 503, an output unit 504, and a display unit 505.

The output unit 504 of FIG. 5 has the same structure and operation as the output unit 304 of FIG. 3.

The display unit 505 of FIG. 5 may display information on resources as in the case of the display unit 305 of FIG. 3. Further, the display unit 505 may display a video signal based on a bit stream that is output from one of the storage unit 503 and the connector 501.

The display unit 505 displays the video signal when multimedia content composed of audio and/or video data is selected. If the multimedia content stored in the first apparatus 100 is selected, the control unit 502 controls the storage unit 503 and the display unit 505, so that a bit stream output from the storage unit 503 is sent to the display unit 505. On the other hand, if multimedia content stored in second apparatus 110 is selected, the control unit 502 controls the connector 501 and the display unit 505, so that a bit stream output from the connector 501 is sent to the display unit 505.

The connector 501, the control unit 502, the storage unit 503, and the display unit 505 respectively have the same functions as the connector 301, the control unit 302, and the display unit 305 shown in FIG. 3. Also, the apparatus of FIG. 5 may include the function unit 205 of FIG. 2.

FIG. 6 is a block diagram of a portable recording and/or playback apparatus according to yet another exemplary embodiment of the present invention. Referring to FIG. 6, the apparatus includes a connector 601, a control unit 602, a storage unit 603, an output unit 604, a display unit 605, and a battery 606.

Except for the battery 606, the apparatus of FIG. 6 has the same structure and operation as the apparatus of FIG. 5. Thus, the connector 601, the control unit 602, the storage unit 603, the output unit 604, and the display unit 605 shown in FIG. 6 may have the same structures and operations of the connector 501, the control unit 502, the storage unit 503, the output unit 504, and the display unit 505, respectively, described above.

The connector 601 is configured to allow power to be shared between the battery 606 and a battery (not shown) included in the second apparatus 110. By sharing power, even when power of the battery 606 or the battery (not shown) included in the second apparatus 110 is depleted, if power of the other battery still remains, the power is provided to the depleted battery, and thus both the first apparatus 100 and the second apparatus 110 can still operate. For this, the connector 601 may have a power share line.

To determine which battery is depleted, batteries connected to the connector 601 and to a connector (not shown) included in the second apparatus 110 monitor each other. Power sharing is achieved according to a result obtained through the monitoring.

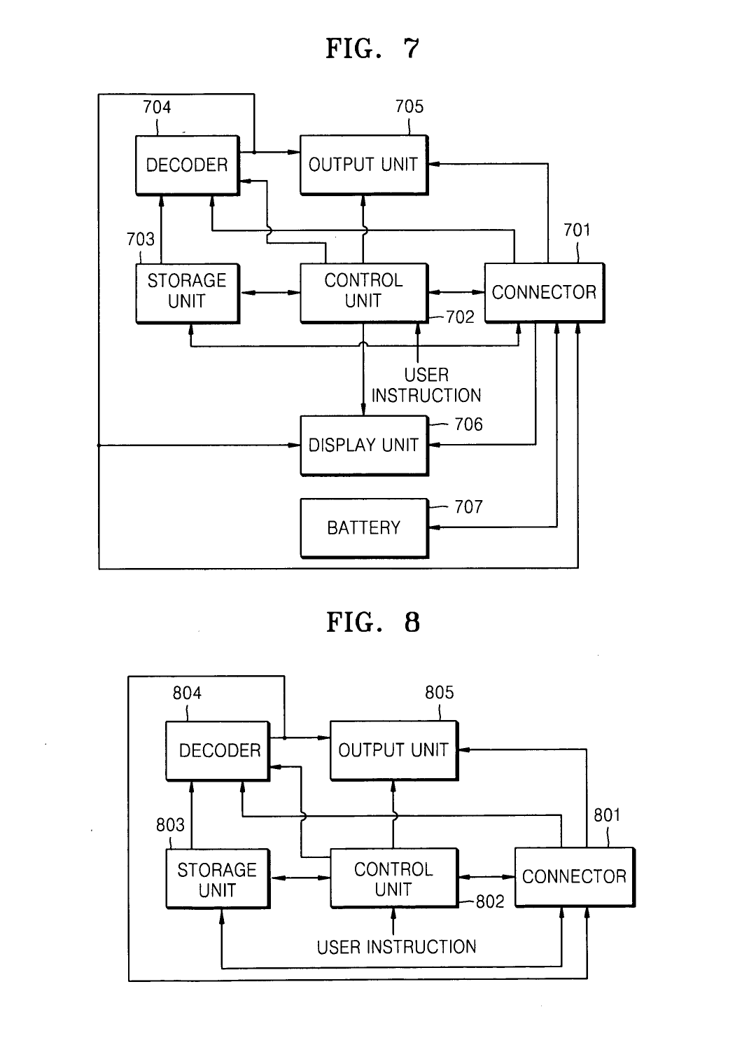

FIG. 7 is a block diagram of a portable recording and/or playback apparatus according to yet another exemplary embodiment of the present invention. Referring to FIG. 7, the apparatus includes a connector 701, a control unit 702, a storage unit 703, a decoder 704, an output unit 705, a display unit 706, and a battery 707.

Except for the decoder 704, the apparatus of FIG. 7 has the same structure and operation as the apparatus of FIG. 6.

The decoder 704 decodes content data that is sent from the storage unit 703 or the connector 701, under the control of the control unit 702. If content stored in the first apparatus 100 is selected, the decoder 704 decodes content data sent from the storage unit 703. If content stored in the second apparatus 110 is selected, the decoder 704 decodes content data sent from the connector 701. In this case, the content data sent from the connector 701 is content data that is not decoded by the second apparatus 110. Data decoded by the decoder 704 is sent to the output unit 705 and the connector 701.

The decoder 704 may provide a decoding result of the content data received by the second apparatus 110 to the second apparatus 110 through the connector 701. This is the case when the second apparatus 110 requests the use of a decoder of the first apparatus 100. Referring to FIG. 1 for example, the second portable recording and/or playback apparatus 110 requests the use of a decoder (not shown) included in the first portable recording and/or playback apparatus 100, while sending un-decoded content data to the first portable recording and/or playback apparatus 100.

The output unit 705 outputs one of decoded content data that is output from the decoder 704 and content data that is output from the connector 701, under the control of the control unit 702. In this case, the content data that is output from the connector 701 is content data decoded by the second apparatus 110.

Thus, if the decoder 704 included in the first apparatus 100 is used when content is played, the content data that is output from the decoder 704 is output through the output unit 705, under the control of the control unit 702. In this case, if the content data includes a video signal, the decoder 704 sends the video signal to the display unit 706. If content stored in the first apparatus 100 is selected, the decoded content data that is output from the decoder 704 is sent to the connector 701. If content stored in the second apparatus 110 is selected, the decoder 704 decodes the content data sent from the connector 701.

In addition, if the decoder (not shown) included in the second apparatus 110 is used when content is played, the content data that is output from the connector 701 is output through the output unit 705, under the control of the control unit 702. In this case, if the content data includes a video signal, the connector 701 sends the video signal to the display unit 706. The selected content data is stored in the second apparatus 110.

In the connector 701, content data decoded in the second apparatus 110 and un-decoded content data in the second apparatus 110 are received through different lines. The connector 701 may receive the decoded content data through an audio data line, and receive the un-decoded content data through a bit stream data line.

FIG. 8 is a block diagram of a portable recording and/or playback apparatus according to yet another exemplary embodiment of the present invention. Referring to FIG. 8, the apparatus includes a connector 801, a control unit 802, a storage unit 803, a decoder 804, and an output unit 805.

The apparatus of FIG. 8 has the same structure and operation as the apparatus of FIG. 2, except for the decoder 804. In addition, the decoder 804 has the same structure and operation as the decoder 704 of FIG. 7, except for the display unit 706. Thus, as described above with reference to FIG. 7, the apparatus of FIG. 8 operates differently depending on whether it uses the decoder 804 included in the first apparatus 100 or the decoder (not shown) included in second apparatus 110, and whether selected content is stored in the first apparatus 100 or to second apparatus 110.

The first portable recording and/or playback apparatus 100 and the second portable recording and/or playback apparatus 120 may each be structured according to any one of the block diagrams of FIGS. 2, 3, and 5 to 8.

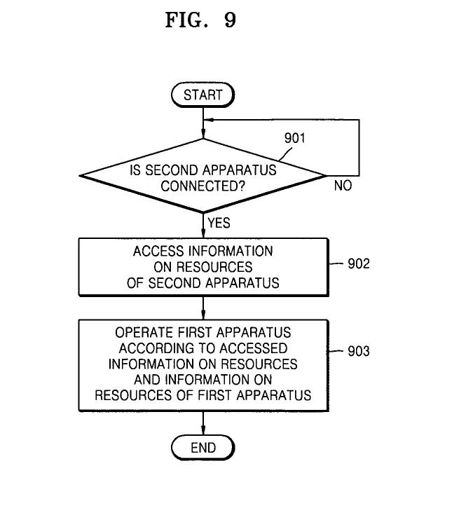

FIG. 9 is a flowchart of an operation method of a portable recording and/or playback apparatus according to an exemplary embodiment of the present invention.

First, it is determined whether a portable recording and/or playback apparatus (hereinafter referred to as a first apparatus) of a user is connected to a portable recording and/or playback apparatus (hereinafter referred to as a second apparatus) of another user (operation 901). By monitoring a connector included in the first apparatus, it can be determined whether the first apparatus is connected to the second apparatus.

If the second apparatus is connected the first apparatus, information on resources of the second apparatus is accessed (operation 902), from a storage unit included in the second apparatus. The information on resources of the second apparatus may be accessed from a file system stored in the storage unit included in the second apparatus.

The first apparatus operates according to the accessed information on resources and also information on resources of the first apparatus (operation 903). The information on resources may be information on content and/or functions, stored in either the first apparatus or the second apparatus.

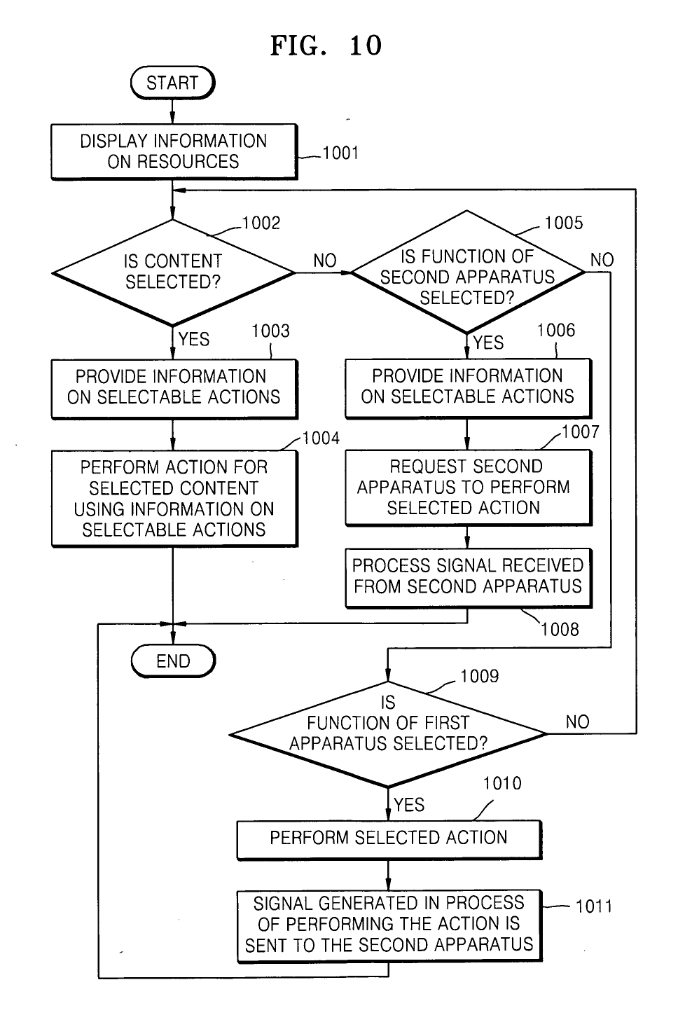

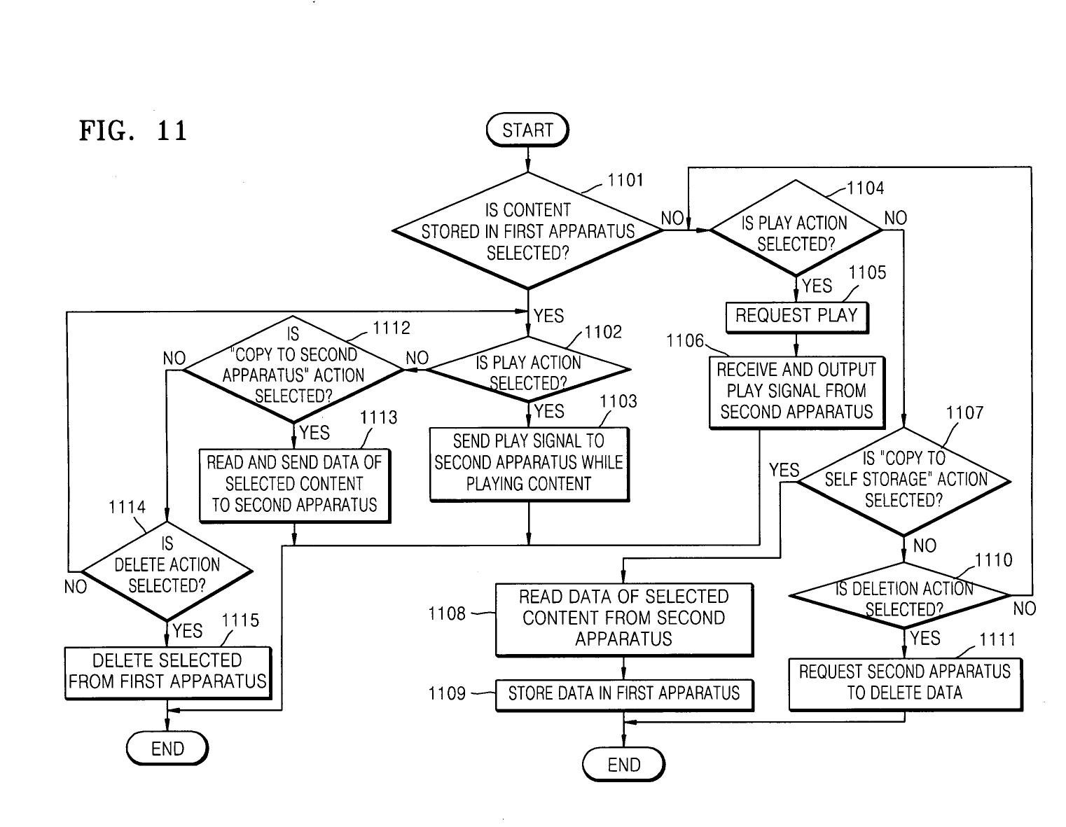

FIG. 10 is a detailed flowchart of the operation 903 of FIG. 9.

The accessed information on resources from the second apparatus and information on resources of the first apparatus are displayed as shown in FIG. 4 (operation 1001).

If content stored in the second apparatus or the first apparatus is selected using the displayed information, information on selectable actions for the selected content is provided (operations 1002 and 1003). The information on selectable actions may be displayed in the form of the popup menu 414 of selectable actions. Thus, the selectable actions may include one or more of actions to play, copy, and delete. If the selected content is stored in the first apparatus, the copy action corresponds to “copy to second apparatus”, and if the selected content is stored in the second apparatus, the copy action corresponds to “copy to first apparatus”.

Using the displayed information on selectable actions, an action is performed for the selected content (operation 1004). The action may be a specific action.

FIG. 11 is a detailed flowchart of the operation 1004 of FIG. 10.

It is determined whether the selected content is stored in the first apparatus (operation 1101).

If it is determined that the selected content is stored in the first apparatus, it is checked whether the specific action is a play action (operation 1102). If the specific action is the play action, a play signal of the selected content is sent to the second apparatus, while the selected content is played (operation 1103).

If it is determined in operation 1101 that the selected content is not stored in the first apparatus, i.e., that the selected content is stored in the second apparatus, and the specific action is the play action (operations 1101 and 1104), the second apparatus is requested to play the selected content (operation 1105). Next, the play signal sent from the second apparatus is received and output by the first apparatus (operation 1106).

If it is determined that the selected content is stored in the second apparatus in operation 1101, and the specific action is “copy to self storage” (operation 1107), selected content data is read from the second apparatus (operation 1108) and stored in the first apparatus (operation 1109).

If it is determined that the selected content is stored in the second apparatus, and the specific action is a deletion action (operation 1110), the selected content data stored in the second apparatus is requested to be deleted (operation 1111).

If it is determined in operation 1101 that the selected content is stored in the first apparatus, and the specific action is “copy to second apparatus” (operation 1112), the selected content data is read and sent to the second apparatus (operation 1113).

If it is determined in operation 1101 that the selected content is stored in the first apparatus, and the specific action is the delete action (operation 1114), the selected content is deleted from the first apparatus (operation 1115).

Returning now to FIG. 10, it is determined in operation 1005 whether one of the functions included in the second apparatus is selected using the information displayed in the operation 1001 FIG.

If it is determined that one of the functions included in the second apparatus is selected, information on selectable actions for the selected function is provided to a user (operation 1006). In this case, the information on selectable actions is the same as the popup menu 423 of selectable actions of FIG. 4.

When the user selects an action using the information on selectable actions, the second apparatus is requested to perform the selected action (operation 1007). For example, if the CH1 421_1 included in the FM reception folder of FIG. 4 is selected in operation 1005, and the play action 424 of FIG. 4 is selected using information on selectable actions in operation 1006, then the second apparatus is requested to receive an FM radio signal of the CH1 421_1 in operation 1007.

If a signal is output from the second apparatus and received according to the request above, the received signal is processed according to the action selected in operation 1007 (operation 1008). In other words, if the play action 424 is selected in operation 1007 from the popup menu 423 of FIG. 4, the signal received in operation 1008 is output from the first apparatus. If the record action 425 is selected in operation 1007 from the popup menu 423 of FIG. 4, the signal received in operation 1008 is stored in the first apparatus.

If any action is selected for the first apparatus using the information displayed in operation 1001, the selected action is performed (operations 1009 and 1010). A signal generated in the process of performing the action is sent to the second apparatus (operation 1011).

The invention can also be embodied as computer readable code on a computer readable recording medium. The computer readable recording medium is any data storage apparatus that can store data which can be thereafter read by a computer system. Examples of the computer readable recording medium include read-only memory (ROM), random-access memory (RAM), CD-ROMs, magnetic tapes, floppy disks, optical data storage apparatuses, and carrier waves (such as data transmission through the Internet). The computer readable recording medium can also be distributed over network coupled computer systems so that the computer readable code is stored and executed in a distributed fashion.

Accordingly, exemplary embodiments of the present invention provide a portable recording and/or playback apparatus that can share resources with another portable recording and/or playback apparatus, where the two apparatuses have symmetrical structures or asymmetrical structures, and an operation method thereof. Therefore, two users having different portable apparatuses can use the same content at the same time using their own apparatuses.

Also, exemplary embodiments of the present invention provide a portable recording and/or playback apparatus that can use functions provided by another portable recording and/or playback apparatus, and an operation method thereof. For example, an FM reception function provided by a first user's apparatus can be used through a second user's apparatus even when the second user's apparatus does not provide the FM reception function.

Although the present inventive concept has been particularly shown and described with reference to exemplary embodiments thereof, it will be understood by those skilled in the art that various changes in form and detail may be made therein without departing from the spirit and scope of the inventive concept as defined by the appended claims. Exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of operating portable apparatuses, the method comprising:
accessing information on resources of a second portable apparatus, if the second portable apparatus is connected to a first portable apparatus; and
operating the first portable apparatus using the accessed information on resources and information on resources of the first portable apparatus.

2. The method of claim 1, further comprising checking whether a first portable apparatus is connected to a second portable apparatus.

3. The method of claim 1, wherein the accessed information on resources comprises information on content or functions of the second portable apparatus, and the information on resources of the first portable apparatus includes information on contend or functions of the first portable apparatus.

4. The method of claim 1, wherein the operating the first portable apparatus comprises:
displaying the accessed information on resources and the information on resources of the first portable apparatus;
if content stored in the first portable apparatus or the second portable apparatus is selected using the displayed information, providing information on selectable actions for the selected content; and
performing an action for the selected content using the provided information on selectable actions.

5. The method of claim 4, wherein the information on selectable actions comprises at least one of a play action, a copy action, and a delete action.

6. The method of claim 4, wherein the performing the action comprises:
playing the selected content and sending a play signal of the selected content to the second portable apparatus, if the selected content is stored in the first portable apparatus and the specific action is a play action; and
requesting the second portable apparatus to play the selected content, and receiving and outputting the play signal sent from the second portable apparatus, if the selected content is stored in the second portable apparatus and the action is a play action.

7. The method of claim 4, wherein the performing the action comprises reading the data of the selected content from the second portable apparatus and storing the data in the first portable apparatus, if the selected content is stored in the second portable apparatus and the specific action is a copy action.

8. The method of claim 7, wherein the copy action is a “copy to self-storage” action.

9. The method of claim 4, wherein the performing the action comprises requesting the deletion of the selected content stored in the second portable apparatus, if the selected content is stored in the second portable apparatus and the specific action is a delete action.

10. The method of claim 4, wherein the performing the action comprises reading the data of the selected content and sending the read data to the second portable apparatus, if the selected content is stored in the first portable apparatus and the specific action is a copy action.

11. The method of claim 10, wherein the copy action is a “copy to second apparatus” action.

12. The method of claim 4, wherein the operating the first portable apparatus further comprises:
if a function of the second portable apparatus is selected using the displayed information, providing information on selectable actions for the selected function;
if an action is selected using the provided information on selectable actions, requesting to the second portable apparatus to perform the selected action; and
if a signal output from the second portable apparatus is received as a result of the requesting, processing the signal according to the selected action.

13. The method of claim 12, wherein operating the first portable apparatus further comprises:
if an action is selected for the first portable apparatus using the displayed information, performing the action; and
sending a signal generated by performing the action to the second portable apparatus.

14. The method of claim 4, wherein operating the first portable apparatus further comprises:
if an action is selected for the first portable apparatus using the displayed information, performing the action; and
sending a signal generated by performing the action to the second portable apparatus.

15. A portable apparatus comprising:
a connector which connects a first portable apparatus and a second portable apparatus;
a storage unit which stores information on content and information on resources of the first portable apparatus;
a control unit which accesses information on resources of the second portable apparatus if the second portable apparatus is connected to the connector, and controls the operation of the first portable apparatus using the accessed information on resources and information on resources stored in the storage unit; and
an output unit which outputs a signal received from the storage unit or the connector, under the control of the control unit,
wherein the storage unit outputs content data requested by the control unit, to the output unit and the connector.

16. The portable apparatus of claim 15, wherein the first portable apparatus and the second portable apparatus send and receive audio data and bit stream data therebetween through the connector.

17. The portable apparatus of claim 15, further comprising:
a function unit which performs functions except for recording and playing content,
wherein, if a user requests the operation of the function unit, the control unit operates the function unit, and
the function unit sends a signal generated by performing an action to the second portable apparatus through the connector.

18. The portable apparatus of claim 15, further comprising a display unit which displays the information on resources.

19. The portable apparatus of claim 18, wherein the display unit displays a video signal based on a bit stream that is output from the storage unit or the connector.

20. The portable apparatus of claim 15, further comprising a battery, wherein the battery and a battery included in the second portable apparatus can share power through the connector.

21. The portable apparatus of claim 20, further comprising a decoder which decodes content data sent from one of the storage unit and the connector, under the control of the control unit,
wherein the content data sent from the connector to the decoder is un-decoded content data,
the output unit outputs data that is output from one of the decoder and the connector, under the control of the control unit, and
data that is output from the connector to the output unit is decoded data.

22. The portable apparatus of claim 15, further comprising a decoder which decodes content data sent from one of the storage unit and the connector, under the control of the control unit,
wherein the content data sent from the connector to the decoder is un-decoded content data,
the output unit outputs data that is output from one of the decoder and the connector, under the control of the control unit, and
data that is output from the connector to the output unit is decoded data.

23. The portable apparatus of claim 15, wherein the portable apparatus is a portable recoding or playback apparatus.
